(19) United States
(12) Patent Application Publication
(10) Pub. No.: US 2013/0055293 A1
(43) Pub. Date: Feb. 28, 2013

(54) SYSTEMS AND METHODS FOR UTILIZING SUPPORTED PLAYERS VIA A SHARED MULTIMEDIA FRAMEWORK

(71) Applicants: Mayur Srinivasan, San Diego, CA (US); Fred Zuill, Poway, CA (US); Frederick F. Hermanson, Annville, PA (US)

(72) Inventors: Mayur Srinivasan, San Diego, CA (US); Fred Zuill, Poway, CA (US); Frederick F. Hermanson, Annville, PA (US)

(73) Assignee: DIVX, LLC, Santa Clara, CA (US)

(21) Appl. No.: 13/337,754

(22) Filed: Dec. 27, 2011

Related U.S. Application Data
(60) Provisional application No. 61/529,856, filed on Aug. 31, 2011.

(51) Int. Cl. G06F 9/46

(52) U.S. Cl. 719/328

(57) ABSTRACT

A multimedia framework capable of facilitating communication between an application and one or more supported players in accordance with embodiments of the invention is disclosed. One embodiment includes a multimedia framework configured to communicate with at least one application and at least one installed player; where the multimedia framework is configured to receive messages from the at least one application; where the multimedia framework is configured to parse the messages and identify a player and an instruction contained within the message; where the multimedia framework is configured to determine whether the identified player is an installed player; where the multimedia framework is configured to identify at least one player command from a set of common player commands based upon the instruction; where the multimedia framework is configured to provide the at least one player command to the identified installed player.

### CROSS-REFERENCE TO RELATED APPLICATIONS

The current application claims priority to U.S. Provisional Patent Application No. 61/529,856 filed Aug. 31, 2011, the disclosure of which is incorporated herein by reference.

### FIELD OF THE INVENTION

The present invention generally relates to consumer electronics devices and more specifically to a shared multimedia framework that allows applications to utilize supported players.

### BACKGROUND OF THE INVENTION

In contrast with user devices that are endowed with resources sufficient for a range of resource intensive functions, such as a personal computer, user devices known as “consumer electronic (CE) devices” are generally resource limited having limited memory and processing power. CE devices, such as mobile phones or Internet televisions, typically also require a significant investment to create and maintain. Therefore, CE devices are often proprietary platforms that include security features, such as proprietary access for CE device updates and other services from CE device managers.

Software can be used to operate and run a CE device. In contrast to software that integrates a device's capabilities, such as an operating system, user oriented software termed as “applications” can allow the CE device to perform a specific task for a user. A player, for example, is typically an application that enables the playback of audio and/or video content. In certain situations, applications can utilize other applications to perform a service, such as where an application, such as a game executing on a user device, calls a player for video playback service of a cut scene. Applications can be natively implemented, or designed specifically to run on a device platform, such as a device's operating system and machine firmware. Natively implemented applications can be contrasted with web applications, which have some or all parts of the application software downloaded from the Internet each time it is run.

Software can be written in a programming language and be communicated as code, which is a machine readable instructional language that complies with a set of rules understandable by the machine. Extensible Markup Language (XML) is a markup language defined by a set of rules by which machine readable instructions can be expressed and communicated. Similarly, an application programing interface (API) is a set of rules that software programs can follow to communicate with each other. The set of rules defined by an API can also define a vocabulary for communication among programs.

### SUMMARY OF THE INVENTION

Systems and methods are disclosed that use multimedia frameworks capable of facilitating communication between an application and one or more supported players. One embodiment includes a user device, including: a processor configured by at least one application and at least one installed player, where each installed player is controlled by a common set of player commands; and a multimedia framework configured to communicate with the at least one application and the at least one installed player; where the multimedia framework is configured to receive messages from the at least one application; where the multimedia framework is configured to parse the messages and identify a player and an instruction contained within the message; where the multimedia framework is configured to determine whether the identified player is an installed player; where the multimedia framework is configured to identify at least one player command from a set of common player commands based upon the instruction; where the multimedia framework is configured to provide the at least one player command to the identified installed player.

In a further embodiment, the multimedia framework is configured to use a catalog of supported players to identify players installed on the user device that are configured to be controlled via a common set of player commands; where the catalog of supported players is configured to be updated independently of the multimedia framework.

In another embodiment, the at least one application provides XML messages to the multimedia framework and the multimedia framework provides commands to the at least one installed player via an API, where the API is common to all of the installed players.

In a still further embodiment, the multimedia framework and the application are configured to communicate directly with each other.

In still another embodiment, where the installed player is natively implemented.

In a yet further embodiment, where the user device is configured by firmware including non-volatile memory in which the operating system, the at least one application, the at least one supported player and the multimedia framework are stored.

In yet another embodiment, where: the processor is further configured by an application platform including: a natively implemented virtual machine configured to execute the at least one application, where the at least one application is a non-natively implemented application executing within the virtual machine; a services container, including; the multimedia framework, where the multimedia framework is natively implemented; and at least one handler configured to handle communication via at least one socket between the at least one application executing within the virtual machine and the multimedia framework in the services container.

In a further embodiment again, where the application platform further includes a porting layer.

Another embodiment again further includes a method of supporting playback of media using at least one player installed on a user device by at least one application executing on the user device, the method including: receiving at least one message from an application using a multimedia framework, where the multimedia framework is implemented on a user device and the message identifies a player and contains at least one instruction; identifying a player referenced in the communication received by the multimedia framework from the application using the multimedia framework; determining whether the identified player is an installed player using the multimedia framework; selecting a command from a common set of commands based upon the at least one instruction using the multimedia framework; and providing the command to the identified installed player using the multimedia framework.

In a further additional embodiment, where the multimedia framework is configured to use a catalog of supported players for determining whether the identified player is an installed player.

In another additional embodiment, where the catalog of supported players is configured to be updated without change to the multimedia framework.

In a still yet further embodiment, where the communication received by the multimedia framework includes an Extensible Markup Language (XML) string.

In still yet another embodiment, where the command is an API, where the API is common to all installed players.

In a still further embodiment again, where the multimedia framework and the application communicate directly with each other.

In still another embodiment again, where the installed player is natively implemented on the user device.

In a still further additional embodiment, where the receiving at least one message from an application using a multimedia framework includes: sending the communication from the application to a services container via a socket interface, where the application is executing within a virtual machine; determining that the communication should be sent to the multimedia framework using a handler in the services container, where the multimedia framework is in the services container; and passing the communication to the multimedia framework using the handler.

In still another additional embodiment, a machine readable medium contains processor instructions, where execution of the instructions by a processor causes the processor to perform a process including: receiving at least one message from an application using a multimedia framework, where the message identifies a player and contains at least one instruction; identifying a player referenced in the communication received by the multimedia framework from the application using the multimedia framework; determining whether the identified player is an installed player using the multimedia framework; selecting a command from a common set of commands based upon the at least one instruction using the multimedia framework; and providing the command to the identified installed player using the multimedia framework.

A yet further embodiment again, the machine readable medium further includes a catalog of supported players.

In yet another embodiment again, the machine readable medium is non-volatile memory.

### BRIEF DESCRIPTION OF THE DRAWINGS

FIG. 1 is a system diagram of user devices running applications that can utilize supported players via a shared multimedia framework and configured to communicate with a content server, player server, application server and update server via the Internet in accordance with an embodiment of the invention.

FIG. 2A is a conceptual illustration of a multimedia framework with access to a dynamically updatable catalog of supported players that facilitates communication between applications utilizing an XML interface and supported players utilizing an API interface in accordance with an embodiment of the invention.

FIG. 2B is a process for an application communicating a message that identifies a player and also includes an instruction for a command that the multimedia framework can send to a player in accordance with an embodiment of the invention.

FIG. 3A is a software stack illustrating a user device including a common application platform running a non-natively implemented application in a virtual machine and a shared services container with services such as a multimedia framework that can be shared by applications executing on the user device in accordance with an embodiment of the invention.

FIG. 3B is a software stack of a services container including a handler layer sitting on top of a service layer including a multimedia framework and players that sit on top of a porting layer in accordance with an embodiment of the invention.

FIG. 4 illustrates a user device including a processor, volatile memory and non-volatile memory including a multimedia framework in accordance with an embodiment of the invention.

### DETAILED DISCLOSURE OF THE INVENTION

Turning now to the drawings, multimedia frameworks capable of facilitating communication between an application and one or more supported players in accordance with embodiments of the invention are illustrated. In numerous embodiments, a multimedia framework is able to utilize a dynamically updatable catalog of supported players to identify supported players and handles communication between applications and the players utilized by the applications using a common set of commands. The catalog is dynamic as it can be updated without updating the multimedia framework. In various embodiments, a multimedia framework communicates with a supported player utilizing an API interface. In certain embodiments, the API interface is common among players and the multimedia framework is able to utilize a uniform vocabulary of commands to communicate with all supported players.

In many embodiments, the multimedia framework communicates with applications via an XML interface. Communication between applications and a multimedia framework can be managed using a handler. In many embodiments, the handler parses communication between the application and the multimedia framework to determine if communication from the application is directed to the multimedia framework. Likewise, a handler can also parse communication from a multimedia framework to determine which application is the intended recipient of the communication. In particular embodiments, an application and multimedia framework can communicate directly without the aid of a handler.

In many embodiments, communication between a multimedia framework and application is performed using XML messages. However, in a multitude of embodiments, communication between a multimedia framework and application may occur utilizing any type of data-interchange formats. In certain embodiments, JavaScript Object Notation (JSON), which is an open standard data-interchange format designed for human-readable data-interchange, is utilized to communicate between a multimedia framework and applications. In various embodiments, communication between a multimedia framework and an application is performed using sockets. Examples of sockets used in several embodiments of the invention include (but are not limited to) Flash/ActionScript XML Sockets. Although socket communication is specifically discussed above, many other forms of communication interfaces can be implemented in accordance with many different embodiments of the invention.

In several embodiments, a multimedia framework enables applications to utilize a set of supported players and to dynamically update the catalog of supported players. In this way, the multimedia framework enables efficient updating of a catalog of supported players without updating the multimedia framework. Thereby, different players can be supported at different times without a corresponding need to update the multimedia framework. Likewise, the number of supported players is arbitrary and can span any number or type of players. Provided the player is included in the catalog of supported players, applications can utilize the player via the multimedia framework. In certain embodiments, some but not all of the players on a user device are supported players.

In many embodiments, a common application platform can include a natively implemented multimedia framework on a user device, commonly utilized by applications running in a natively implemented virtual machine on a user device. In certain embodiments, natively implemented players can be utilized as part of a service container of a common application platform. Implementing a multimedia framework and players natively allows for code to be executed more efficiently than the same code executing within a virtual machine. Therefore, resource intensive tasks such as media decoding can be performed much more efficiently using a multimedia framework as opposed to attempting to perform the same function using code executing within a virtual machine. In further embodiments, the multimedia framework and players can be loaded out of of a services layer in a services container.

Although certain embodiments are discussed above, there are many additional ways to implement a multimedia framework in accordance with many embodiments of the invention. System architectures that implement common multimedia frameworks on user devices are discussed in greater detail below.

### System Architecture

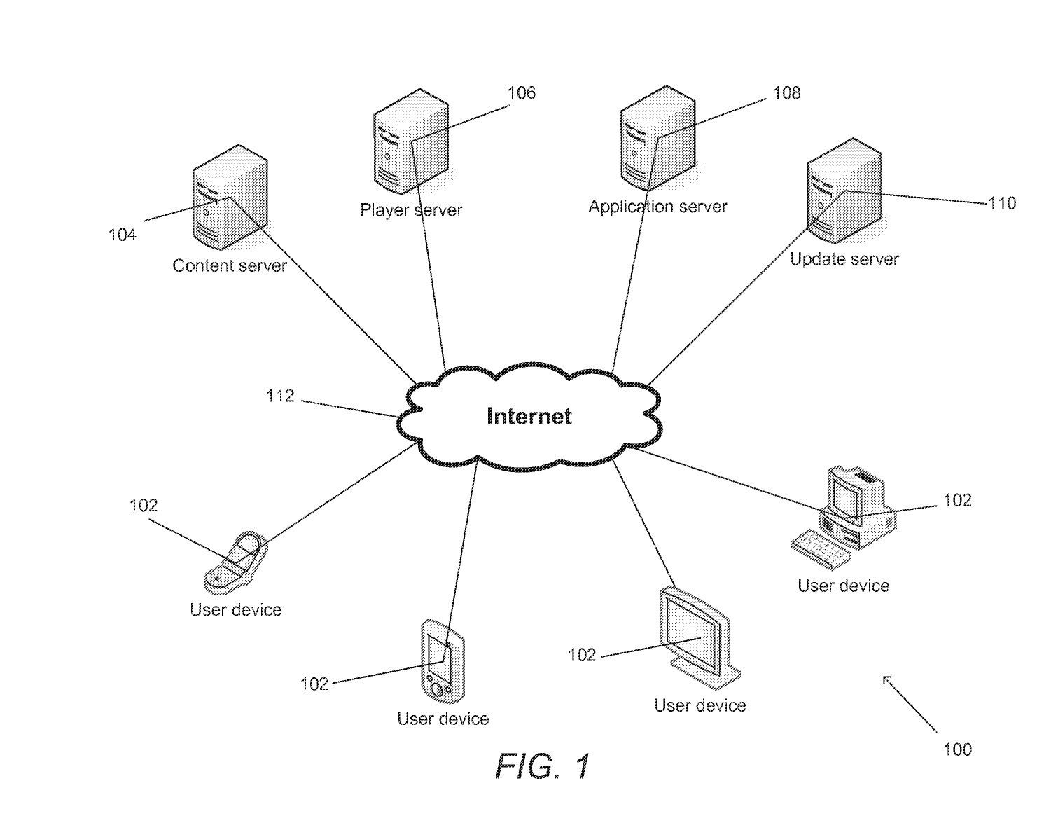

Network connected user devices in accordance with embodiments of the invention can utilize a multimedia framework that enables applications to access players for the playback of content. A system diagram including a number of user devices connected to various servers in accordance with an embodiment of the invention is illustrated in FIG. 1. The system 100 includes various user devices 102 that are connected to a content server 104, player server 106, application server 108 and update server 110 via the Internet 112. User devices 102 that can utilize a multimedia framework range from consumer electronic devices with limited resources all the way to resource endowed user devices capable of performing resource intensive tasks. These user devices 102 include applications configured to run on the user device 102 capable of utilizing players for content playback via the multimedia framework. In certain embodiments, the user devices 102 include a multimedia framework loaded out of a services container that can be shared by applications running on top of the services container, including applications running within a virtual machine and natively implemented applications in the user device. In particular embodiments, the application platform also includes a thin porting layer that allows the applications running within a virtual machine to be combined with the services container on which it runs in order to form a portable application platform for non-native applications that can utilize natively implemented services. In a number of embodiments, a multimedia framework can be stand alone and used by any application on a user device in order to utilize supported players for the playback of content. In numerous embodiments, the multimedia framework utilizes a catalog of supported players that can be dynamically updated without updating the multimedia framework that defines the supported players.

In many embodiments, user devices that include a multimedia framework can access content and updates as well as download players and applications over a network such as the Internet. An update server provides updates to the user device, including updates to a multimedia framework or a catalog of supported players, over the Internet. Likewise, a player server and application server allows for the installation and/or update of players and applications over the Internet. Players utilized by applications via a multimedia framework can access content either locally or remotely over the Internet on a content server for streaming playback on a user device.

Although specific embodiments are recited above, user devices including a multimedia framework can be configured in many different ways such as where the network architecture is implemented as a single server performing the function of all or a combination of a content server, player server, application server and update server. Common multimedia frameworks that can be utilized by an application to access supported players in accordance with embodiments of the invention are discussed further below.

### Multimedia Framework

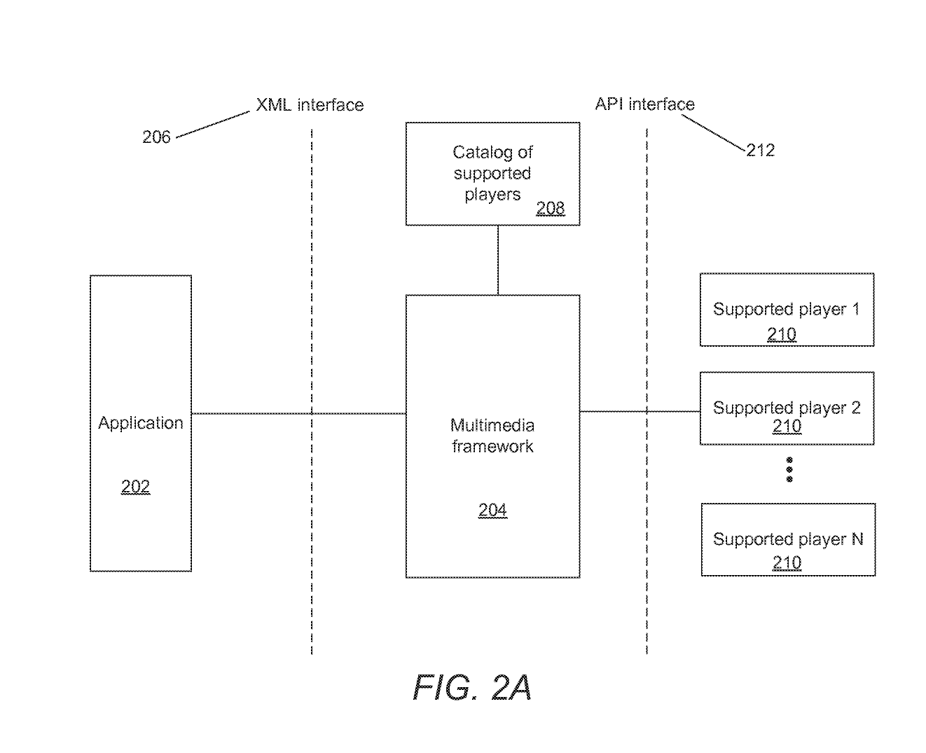

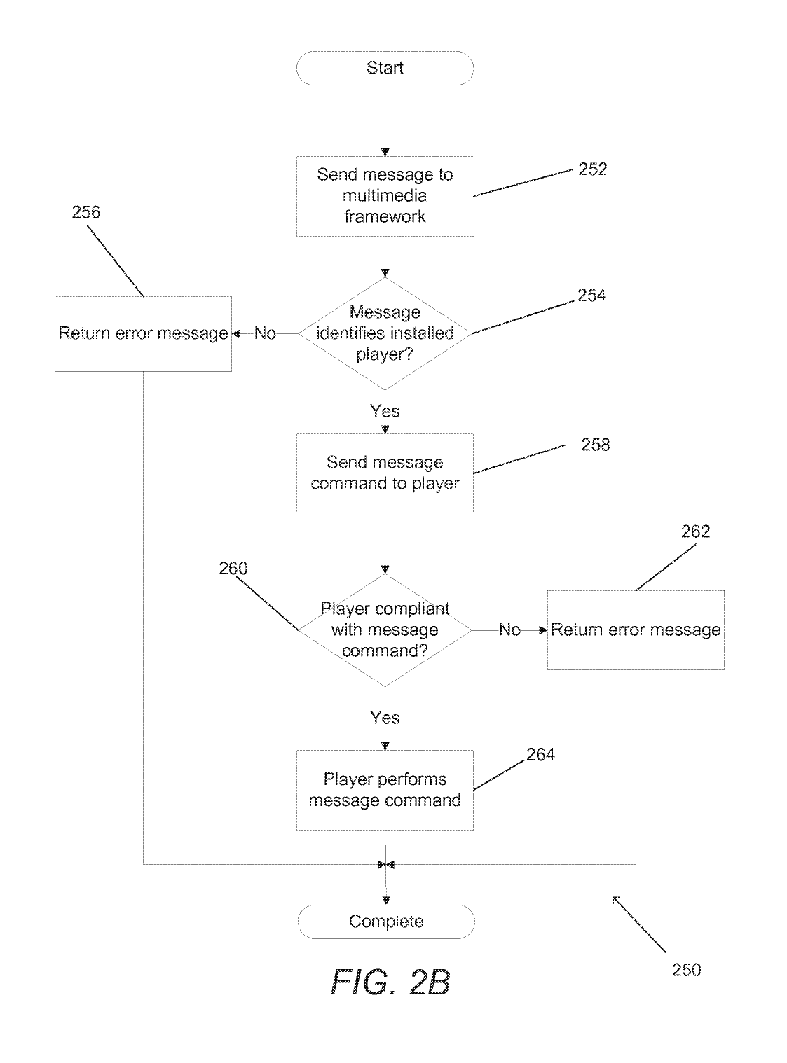

Multimedia frameworks in accordance with embodiments of the invention enable applications running on a user device to utilize supported players. In many embodiments, a common multimedia framework can sit between an application and supported players. The applications can communicate with the multimedia framework using XML and the multimedia framework can parse the XML and provide necessary instructions to the supported players via a common API. In this way, the implementation of the applications and the players can be made largely independent of each other. A conceptual illustration of a multimedia framework utilizing a catalog of supported players and facilitating communication between an application and the supported players in accordance with an embodiment of the invention is illustrated in FIG. 2. In the illustrated embodiment, an application 202 communicates with a multimedia framework 204 via an XML interface 206. The multimedia framework 204 includes a catalog 208 identifying the supported players present on the playback device and can pass commands to any of the supported players 210 via an API interface 212. In several embodiments, applications are not tied to any particular application and a multimedia framework can facilitate a single application utilizing many different types of players for playback. In multiple embodiments, a multimedia framework can provide an application with the ability to utilize supported players with multiple subtitles, audio switching and/or different encryption schemes for playback. In many embodiments, communication between applications 202 and a multimedia framework 204 is facilitated by handers. The handlers are able to parse an XML string received from an application or the multimedia framework to determine the intended destination of the XML string of data. In various embodiments, communication between an application 202 and a multimedia framework 204 can be direct and without the use of handlers, such as where an application directly communicates with the multimedia framework.

In many embodiments, an application communicates a message to a multimedia framework with an instruction for a player. The multimedia framework will then communicate a command associated with the instruction to the player if the player is identified as an installed player by the multimedia framework. A process for supporting playback of media using a player installed on a user device by an application in accordance with an embodiment of the invention is illustrated in FIG. 2B. The process 250 includes sending (252) a message from the application to the multimedia framework. In many embodiments, the message is an XML message that identifies a player and also includes an instruction for a command to the identified player. A decision (254) is made as to whether the message identifies an installed player. In many embodiments, the decision (254) is made by the multimedia framework which utilizes a catalog of supported players with which a player can be identified as being an installed player. If the message does not identify an installed player, the multimedia framework returns (256) an error message to the application. In several embodiments, the error message is in XML and simply identifies that the identified player is not an installed player. If the message identifies an installed player, the multimedia framework will send (258) a command to the installed player that corresponds to an instruction from the message to the installed player. In a number of embodiments, a command to the installed player uses an API interface that is uniform to all installed players. A decision (260) is also made by the installed player as to whether the player can be compliant with the message command. In certain embodiments, a player not being compliant with a message command includes the circumstance where the content associated with a playback command cannot be found. If the player cannot comply with the message command, then the player returns (262) an error message to the multimedia framework, which then returns (262) the error message to the application. In many embodiments, this error message is sent to the multimedia framework across an API interface and is sent from the multimedia framework to an application over an XML interface. If the player can comply with the message command, then the player performs (264) the message command and the process is complete. In many embodiments, a multimedia framework can send messages to an application via the multimedia framework that are unsolicited by that application, such as information on playback position updates or errors in playback. Although a specific process is discussed with respect to FIG. 2B, many different process for supporting playback of media using a player installed on a user device can be implemented in accordance with many embodiments of the invention.

In several embodiments, a multimedia framework can utilize a catalog of supported players that can be updated without updating either the multimedia framework or any of the supported players. Thereby, any changes to the list of supported players, such as a removal of players that are out of date or players with security defects, can be easily and effectively dealt with by using updates to the catalog of supported players. Thereby, a multimedia framework can easily update its catalog of supported player where a device has numerous players installed onto the device but only a subset of those installed players are actually supported. Thereby, the device does not need to deal with unsupported players, such as by uninstalling out of date players, as only the catalog of supported players needs to be updated to exclude the unsupported players for playback by applications utilizing the multimedia framework. In certain embodiments, all supported players can utilize the same API interface, meaning that the same API vocabulary (including commands such as “play”) is universally understood across all supported players.

### Multimedia Framework as a Service

Multimedia frameworks in accordance with embodiments of the invention can be designed as part of a common application platform where a multimedia framework can be loaded from a services container and be shared by a number of different applications. The multimedia framework and the applications can communicate with each other using a handler that also resides in the services container. Additionally, a developer seeking to port the common application platform to a new device can include a porting layer in the application platform.

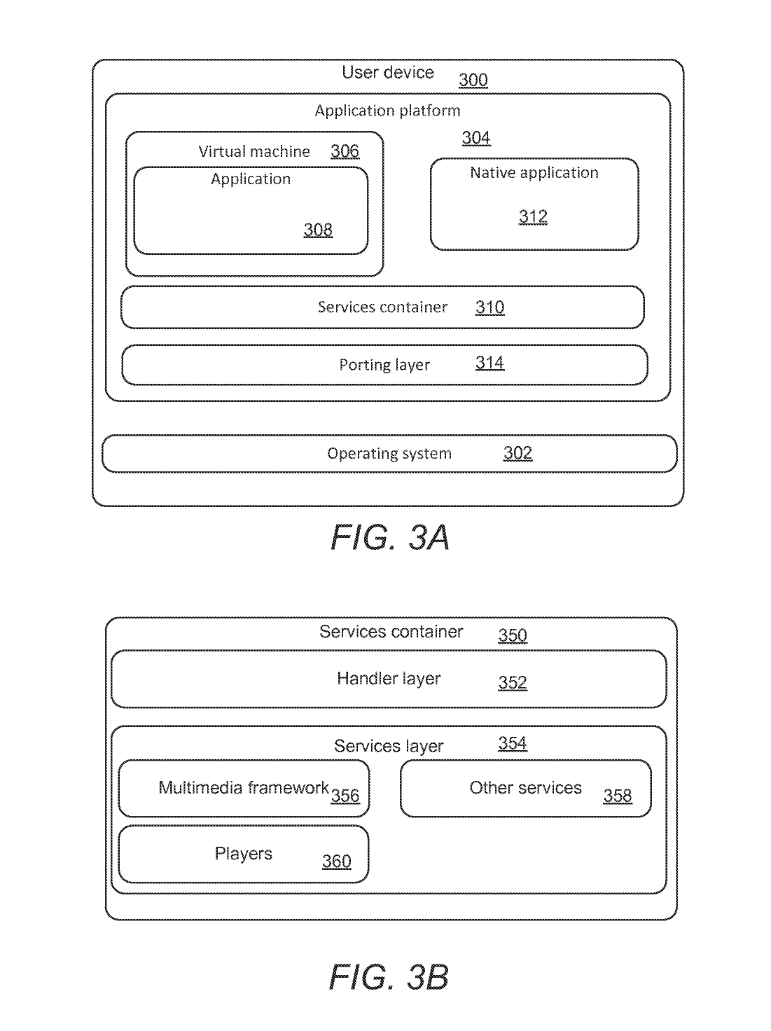

A software stack of a device platform including a common application platform with a services container which can load a multimedia framework in accordance with an embodiment of the invention is illustrated in FIG. 3A. The software stack operates within a user device 300 and includes a device platform 302, such as a device's operating system, and a common application platform 304. The common application platform 304 includes one or more virtual machines 306 capable of running non-natively implemented applications 308 and a services container 310 accessible by applications 308 executing on top of the services container and within the application platform 304. Referring to FIG. 2A, in several embodiments an application 202 running in a virtual machine in an application platform communicates with a multimedia framework 204 which can be loaded by a services container with access to a catalog of supported players 208. The loaded multimedia framework 204 can facilitate communication between an application 202 and any number of supported players 210. In many embodiments, natively implemented applications 312 can access the services in the services container 310 as well, such as by loading the multimedia framework. Similarly referring to FIG. 2B, in many embodiments a message is sent (252) from an application to a multimedia framework loaded from a services container, which decides (254) whether the message is for an installed player and forwards (258) message commands to a player. Likewise, a player can determine (260) whether it can comply with a message and perform (264) a message command. Numerous examples of common application platforms are discussed in U.S. patent application Ser. No. 13/223,053 entitled “Systems and Methods for Common Application Platforms Utilizing Shared Services”, hereby incorporated by reference in its entirety.

Services containers, in accordance with many embodiments of the invention, can include a services layer that can load a multimedia framework as well as players that can be utilized by applications via the multimedia framework. A services container including a services layer with a multimedia framework is illustrated in FIG. 3B. The services container 350 includes a handler layer 352 that sits on top of a services layer 354, which from which a multimedia framework 356 can be loaded as well as other services 358 that can sit on top of players 360, which include supported players, all of which sit on top of a porting layer 314. In many embodiments, the services layer 354 can include a number of services beyond the multimedia framework 356, which can use the supported players for content playback as well. In several embodiments, the porting layer 314 allows for an application platform to be ported among different user devices without needing to change the source code of the application platform. In various embodiments, the porting layer 314 is part of an application platform 304 where the entire application platform sits on top of the porting layer 314. In particular embodiments, a porting layer 314 is specifically part of the players 360.

In many embodiments, the handler layer 352 can handle communication via sockets between an application, including applications configured to execute within a virtual machine of a user device, and a multimedia framework 356 or other service 358 within the services container 350. In certain embodiments, a hander would intercept a message from an application, identify that the message was meant for the multimedia framework by parsing the message and to pass the message over to the multimedia framework. Similarly in specific embodiments, a handler could intercept a message from a multimedia framework, identify that the message was meant for a particular application and pass the message over to the particular application. Although specific embodiments of a multimedia framework as a service are discussed above, many other variations of a multimedia framework as a service in accordance with embodiments of the invention are possible, including embodiments where the players are not loadable from the services layer but are otherwise natively implemented on the user device or where the players are accessible over the Internet.

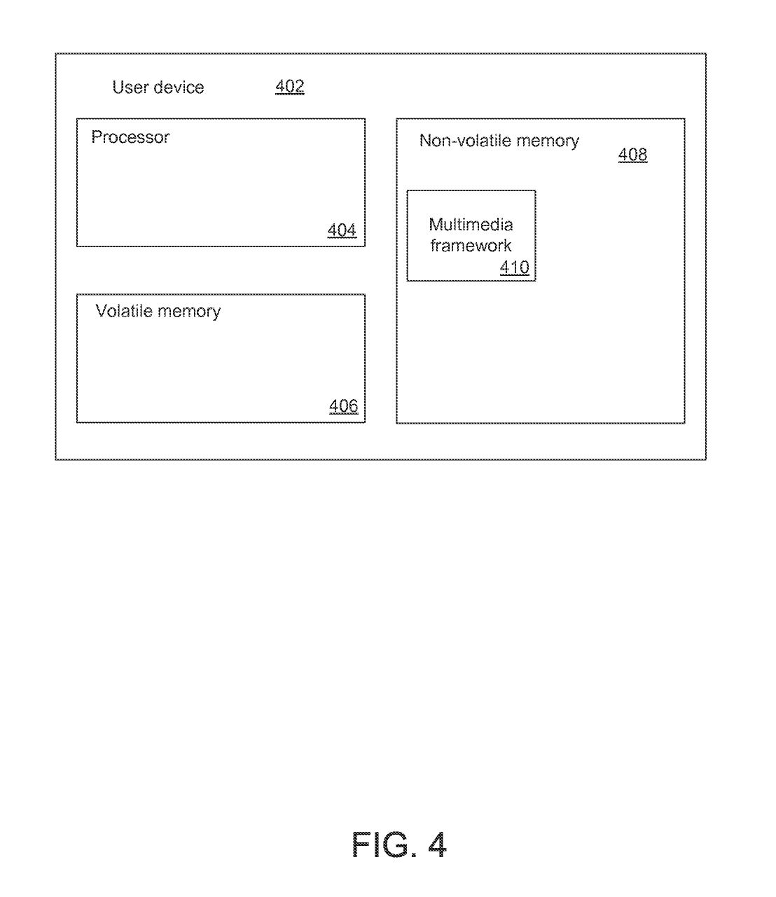

User devices in accordance with many embodiments of the invention can load a multimedia framework as machine readable instructions from memory stored in a user device. This memory can be volatile or non-volatile memory. A multimedia framework loaded from non-volatile memory that configures a processor to encode video in accordance with an embodiment of the invention is illustrated in FIG. 4. The user device 402 includes a processor 404, volatile memory 406 and non-volatile memory 408 that includes a multimedia framework 410. In the illustrated embodiment, the non-volatile memory 408 is a machine readable media that is utilized to store the machine readable instructions that configure the processor 404. The non-volatile memory 408 contains the instructions (410), as a multimedia framework 410, utilized to configure the processor 404 of a user device to allow applications running on a user device to utilize supported players. In many embodiments, a multimedia framework 410 can be loaded from any kind of memory including volatile memory in accordance with many embodiments of the embodiment. Although a specific user device is described above with respect to a multimedia framework loaded from non-volatile memory, any of a variety of user devices can be utilized with a multimedia framework, operating system, at least one application, and at least one player loaded from non-volatile or volatile memory as appropriate to specific applications in accordance with many embodiments of the invention.

While the above description contains many specific embodiments of the invention, these should not be construed as limitations on the scope of the invention, but rather as an example of one embodiment thereof It is therefore to be understood that the present invention may be practiced otherwise than specifically described, including various changes in the implementation such as utilizing multimedia frameworks that support features beyond those described above, without departing from the scope and spirit of the present invention. Thus, embodiments of the present invention should be considered in all respects as illustrative and not restrictive.

What is claimed is:

1. A user device, comprising:
a processor configured by at least one application and at least one installed player, where each installed player is controlled by a common set of player commands; and
a multimedia framework configured to communicate with the at least one application and the at least one installed player;
wherein the multimedia framework is configured to receive messages from the at least one application;
wherein the multimedia framework is configured to parse the messages and identify a player and an instruction contained within the message;
wherein the multimedia framework is configured to determine whether the identified player is an installed player;
wherein the multimedia framework is configured to identify at least one player command from a set of common player commands based upon the instruction;
wherein the multimedia framework is configured to provide the at least one player command to the identified installed player.

2. The user device of claim 1, wherein:
the multimedia framework is configured to use a catalog of supported players to identify players installed on the user device that are configured to be controlled via a common set of player commands;
wherein the catalog of supported players is configured to be updated independently of the multimedia framework.

3. The user device of claim 1, wherein the at least one application provides XML messages to the multimedia framework and the multimedia framework provides commands to the at least one installed player via an API, where the API is common to all of the installed players.

4. The user device of claim 1, wherein the multimedia framework and the application are configured to communicate directly with each other.

5. The user device of claim 1, wherein the installed player is natively implemented.

6. The user device of claim 1, wherein the user device is configured by firmware comprising non-volatile memory in which the operating system, the at least one application, the at least one supported player and the multimedia framework are stored.

7. The user device of claim 1, wherein:
the processor is further configured by an application platform comprising:
a natively implemented virtual machine configured to execute the at least one application, wherein the at least one application is a non-natively implemented application executing within the virtual machine;
a services container, comprising;
the multimedia framework, wherein the multimedia framework is natively implemented; and
at least one handler configured to handle communication via at least one socket between the at least one application executing within the virtual machine and the multimedia framework in the services container.

8. The user device of claim 7, wherein the application platform further comprises a porting layer.

9. A method of supporting playback of media using at least one player installed on a user device by at least one application executing on the user device, the method comprising:
receiving at least one message from an application using a multimedia framework, wherein the multimedia framework is implemented on a user device and the message identifies a player and contains at least one instruction;
identifying a player referenced in the communication received by the multimedia framework from the application using the multimedia framework;
determining whether the identified player is an installed player using the multimedia framework;
selecting a command from a common set of commands based upon the at least one instruction using the multimedia framework; and
providing the command to the identified installed player using the multimedia framework.

10. The method of claim 9, wherein the multimedia framework is configured to use a catalog of supported players for determining whether the identified player is an installed player.

11. The method of claim 10, wherein the catalog of supported players is configured to be updated without change to the multimedia framework.

12. The method of claim 9, wherein the communication received by the multimedia framework comprises an Extensible Markup Language (XML) string.

13. The method of claim 9, wherein the command is an API, where the API is common to all installed players.

14. The method of claim 9, wherein the multimedia framework and the application communicate directly with each other.

15. The method of claim 9, wherein the installed player is natively implemented on the user device.

16. The method of claim 9, wherein the receiving at least one message from an application using a multimedia framework comprises:
sending the communication from the application to a services container via a socket interface, wherein the application is executing within a virtual machine;
determining that the communication should be sent to the multimedia framework using a handler in the services container, wherein the multimedia framework is in the services container; and
passing the communication to the multimedia framework using the handler.

17. A machine readable medium containing processor instructions, where execution of the instructions by a processor causes the processor to perform a process comprising:
receiving at least one message from an application using a multimedia framework, where the message identifies a player and contains at least one instruction;
identifying a player referenced in the communication received by the multimedia framework from the application using the multimedia framework;
determining whether the identified player is an installed player using the multimedia framework;
selecting a command from a common set of commands based upon the at least one instruction using the multimedia framework; and
providing the command to the identified installed player using the multimedia framework.

18. The machine readable medium of claim 17, where the machine readable medium further comprises a catalog of supported players.

19. The machine readable medium of claim 17, wherein the machine readable medium is non-volatile memory.
